(19) United States
(12) Patent Application Publication
(10) Pub. No.: US 2023/0214547 A1
(43) Pub. Date: Jul. 6, 2023

(54) SERVERS, SYSTEMS, AND METHODS FOR IMPROVING FLUID NETWORKS

(71) Applicant: AVEVA SOFTWARE, LLC, Lake Forest, CA (US)

(72) Inventors: Pavan K. Veldandi, Hyderabad (IN); Anuradha Durvasula, Hyderabad (IN); Suresh Jayaraman, Chennai (IN)

(21) Appl. No.: 18/088,112

(22) Filed: Dec. 23, 2022

Related U.S. Application Data
(60) Provisional application No. 63/295,635, filed on Dec. 31, 2021.

(51) Int. Cl. G06F 30/18; G06F 30/20; G06Q 10/0631

(52) U.S. Cl. CPC G06F 30/18; G06F 30/20; G06Q 10/06313; G06F 2113/08

(57) ABSTRACT

The disclosure is directed to a system for generating suggested routing for waste fluid from a source component to a sink component that can use the waste fluid in a fluid process according to some embodiments. In some embodiments, the system is configured to determine usability of the waste fluid in various fluid processes by accessing contamination history from a fluid processes and calculating an acceptable amount of contamination to use in a different fluid process. The system is configured to provide different types of waste fluid from different processes at various flowrates to one or more sink components to ensure contamination thresholds for the sink processes are not violated according to some embodiments.

### CROSS-REFERENCE TO RELATED APPLICATION

This application claims the benefit of and priority to U.S. Provisional Application No. 63/295,635, filed Dec. 31, 2021, which is hereby incorporated herein by reference in its entirety for all purposes.

### BACKGROUND

The implementation of sustainable water management practices, including recycling and reuse of water, helps minimize production costs and the environmental impact of industrial processes. Such processes include those used in chemical, food, and beverage manufacturing plants and facilities. Currently, water optimization is done before a manufacturing facility is constructed. These calculations are tedious and do not take real-world conditions into account. Often, this approach results in inefficient systems, but current modeling methods do not have the capability to suggest new arrangements to save resources including, without limitation, water.

Therefore, there is a need in the art for a system that can accept actual process conditions into a simulation model and automatically generate new connections suggestions and/or implement automatic valve line-ups.

### SUMMARY

In some embodiments, the disclosure is directed to a system for determining optimum routing for wastewater in an industrial process In some embodiments, the system comprises one or more computers comprising one or more processors and one or more non-transitory computer readable media, the one or more non-transitory computer readable media having instructions stored thereon that when executed cause the one or more computers to implement one or more steps. In some embodiments, a step includes instructions to receive, by the one or more processors, one or more contamination threshold values for each of one or more fluid processes. In some embodiments, a step includes instructions to receive, by the one or more processors, contamination production data for each of the one or more fluid processes. In some embodiments, a step includes instructions to execute, by the one or more processors, one or more contamination calculations. In some embodiments, a step includes instructions to determine, by the one or more processors, a contaminated fluid route.

In some embodiments, the contaminated fluid route comprises a representation of one or more industrial components (e.g., pumps, valves, and/or piping) needed to route contaminated fluid from at least one of the one or more fluid process to at least one other of the one or more fluid processes. In some embodiments, a step includes instructions to generate, by the one or more processors, a simulation model of an industrial process comprising the contaminated fluid route. In some embodiments, the system comprise one or more controllers. In some embodiments, a step includes instructions to send, by the one or more processors, a command to the one or more controllers to change a physical component line-up to initiate the contaminated fluid route.

In some embodiments, contamination production data comprises a contamination concentration comprising one or more types of contamination per unit of fluid leaving one or more of the one or more fluid processes. In some embodiments, each of one or more contamination calculations are configured to determine a rate at which contaminated fluid can be received by a respective each of the one or more fluid processes before a respective contamination threshold value is reached for each of the one or more fluid processes. In some embodiments, the respective contamination threshold value includes a limit to the contamination concentration.

In some embodiments, each of one or more contamination calculations are configured to determine an amount of contaminated fluid that can be received by a respective each of the one or more fluid processes before a respective contamination threshold value is reached for each of the one or more fluid processes. In some embodiments, the respective contamination threshold value includes a limit to the contamination concentration.

In some embodiments, the one or more non-transitory computer readable media have further instructions stored thereon that when executed cause the one or more computers to generate, by the one or more processors, the contaminated fluid route in a simulation model of an industrial process comprising the one or more fluid processes. In some embodiments, a step includes instructions to assign, by the one or more processors, one or more source component designations or one or more sink component designations for each of the one or more fluid processes. In some embodiments, the one or more source component designations or the one or more sink component designations result in one or more source components and/or one or more sink components, respectively.

In some embodiments, the one or more sink components are configured to execute a sink process that at least partially requires an input of a same process fluid that the one or more source components use to execute a source process. In some embodiments, the one or more source component designations are based on a source fluid output from the one or more fluid processes comprising a higher contamination value than a source fluid input to the one or more fluid processes. In some embodiments, the one or more sink component designations are based on a sink fluid output from the one or more fluid processes, the sink fluid output comprising a lower contamination value than the source fluid output. In some embodiments, the one or more sink component designations are based on a contamination value of the sink fluid output being below a respective contamination threshold value.

In some embodiments, a step includes instructions to generate, by the one or more processors, an industrial simulation of a physical industrial process, the industrial simulation comprising one or more representations of one or more fluid processes. In some embodiments, a step includes instructions to receive, by the one or more processors, one or more waste fluid threshold values for each of one or more fluid processes. In some embodiments, a step includes instructions to receive, by the one or more processors, waste fluid production data for each of one or more fluid processes. In some embodiments, a step includes instructions to execute, by the one or more processors, one or more waste fluid calculations. In some embodiments, a step includes instructions to generate, by the one or more processors, one or more waste fluid routing proposals on the industrial simulation.

In some embodiments, each of one or more waste fluid calculations are configured to determine an amount of waste fluid that can be received by a respective each of the one or more fluid processes. In some embodiments, each of the one or more waste fluid routing proposals include one or more digital components configured to deliver one or more source fluid outputs comprising waste fluid to one or more one sink components within the industrial simulation. In some embodiments, at least one of the one or more digital components represent existing components in the physical industrial process. In some embodiments, at least one of the one or more digital components comprise a suggested component. In some embodiments, the suggested component does not currently exist in the physical industrial process.

In some embodiments, the one or more non-transitory computer readable media have further instructions stored thereon that when executed cause the one or more computers to execute, by the one or more processors, an optimization simulation. In some embodiments, the optimization simulation includes one or more waste fluid routing proposal simulations. In some embodiments, a step includes instructions to the optimization simulation includes at least partially replacing existing fluid entering one or more sink components with waste fluid from one or more source components.

In some embodiments, the one or more non-transitory computer readable media have further instructions stored thereon that when executed cause the one or more computers to execute, by the one or more processors, a change in physical component line-up in the physical industrial process to initiate the one or more waste fluid routing proposals. In some embodiments, a step includes instructions to execute, by the one or more processors, a contamination sink flowrate calculation. In some embodiments, the contamination sink flowrate calculation is configured to provide a flowrate of waste fluid to the one or more sink components that results in a sink component fluid output remaining below a contamination threshold value.

In some embodiments, the one or more waste fluid routing proposals includes a lowest cost calculation. In some embodiments, the lowest cost calculation includes a selection of physical components that require a lowest energy for transporting the one or more source fluid outputs to the one or more sink components. In some embodiments, the lowest cost calculation includes a selection of physical components that require a lowest cost for transporting the one or more source fluid outputs to the one or more sink components. In some embodiments, the lowest cost calculation includes an optimized component calculation. In some embodiments, the optimized component calculation includes one or more suggested new components required to transport the one or more source fluid outputs to the one or more sink components. In some embodiments, the one or more suggested new components are selected by determining a lowest cost of available component options, including pipes, valves, and/or pumps.

### DRAWING DESCRIPTION

FIG. 1 shows a non-limiting example of fluid pinch analysis applied to a process according to some embodiments.

FIG. 2 depicts a non-limiting example savings table according to some embodiments.

FIG. 3 illustrates a non-limiting example process flow according to some embodiments.

FIG. 4 shows an ethanol process as a non-limiting example use case according to some embodiments.

FIG. 5 shows a first step of collecting data for each source and sink according to some embodiments.

FIG. 6 shows a second step including feeding the data into the system to determine the pinch point and/or optimized network design according to some embodiments.

FIGS. 7-12 depict various stages of the system automatically generating the new connections in the model according to some embodiments.

FIG. 13 illustrates a computer system 910 enabling or comprising the systems and methods in accordance with some embodiments of the system.

### DETAILED DESCRIPTION

In some embodiments, the system is configured to execute one or more pinch analyses as part of a systemic water-using reduction strategy. In some embodiments, the system is configured to use pinch analysis to integrate one or more water consuming activities within a process. In some embodiments, pinch analysis includes a systematic approach for developing a water network. In some embodiments, pinch analysis includes determining one or more targets for freshwater usage and/or wastewater production. In some embodiments, the system is configured to analyze one or more fluid streams and identify possible water reuse areas by matching different sources and sinks. In some embodiments, the system is configured to automatically generate a process model based on the analysis.

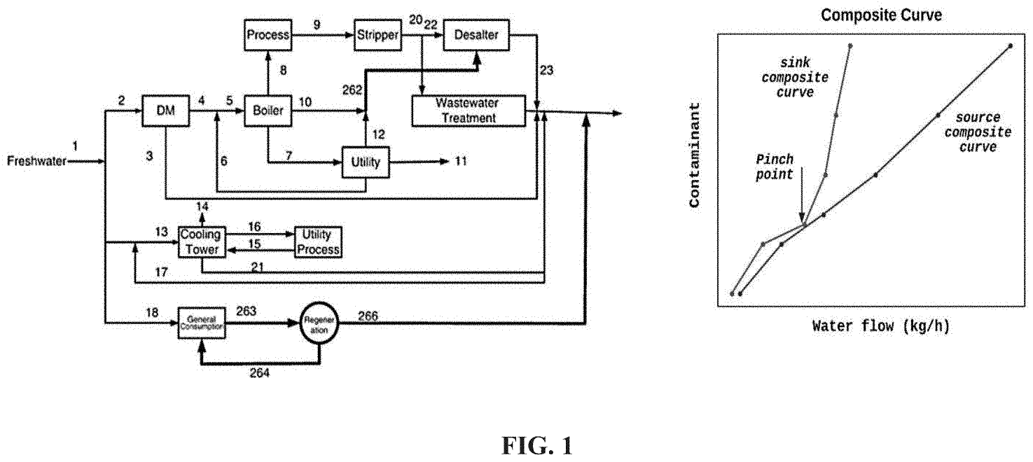

In some embodiments, pinch analysis includes applying a constraint-based optimization technique to a sink (i.e., water requirement) and a source (i.e., water availability). In some embodiments, a source may include a fluid flow from a process that comprises one or more contaminates, while a sink may be a process that requires a particular fluid quality. In some embodiments, the system includes a graphical user interface (GUI) configured to enable a user to build a process model and to enable a user to configure the model to receive one or more mass flowrates and/or water quality metric inputs into the process model. FIG. 1 shows a non-limiting example of pinch analysis applied to a process according to some embodiments.

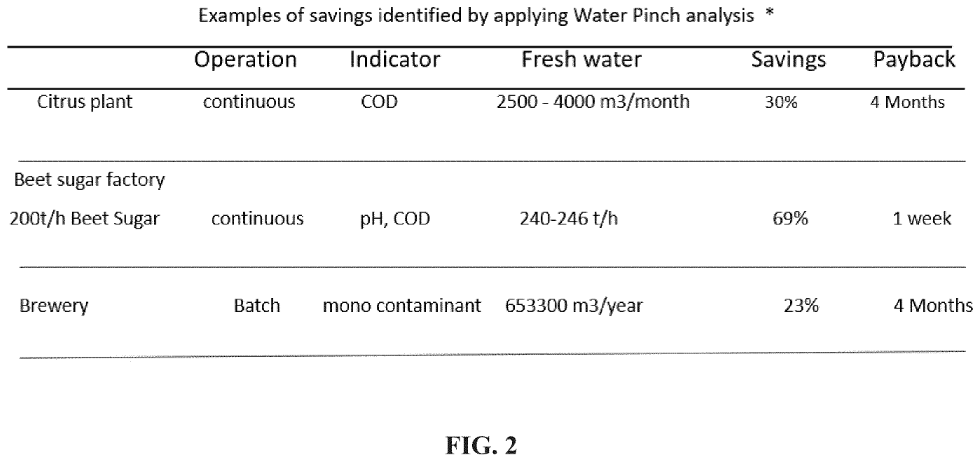

FIG. 2 depicts a non-limiting example savings table according to some embodiments. In some embodiments, the system results in water conservation and cost savings from a reduction in wastewater discharged and/or freshwater being introduced. In some embodiments, the system is readily incorporable into any industrial process that uses a fluid that can also be recycled into other process areas (e.g., refineries, petro chemical, etc.)

In some embodiments, the system includes (e.g., Python™) process libraries, (e.g., Python™ open source libraries) application programming interfaces (APIs), and/or and advanced scheduler (e.g., Advance Python™ Scheduler (APS)). In some embodiments, the system is configured to use the advanced scheduler to execute code at a predetermined time, once, and/or periodically. In some embodiments, the system includes a custom (e.g., Python™) script to integrate a translator (e.g, PINA (Python-to-OpenCL translator)) and APS. In some embodiments, one or more process libraries are used to generate water network target plots. Although some embodiments are directed to water, it is understood that “water” and a broader recitation of “fluid” are exchangeable when defining the metes and bounds of the system. In some embodiments, the system is configured to determine the cost of optimizing piping layout for a water network. In some embodiments, the system is integrated with AVEVA® Unified Engineering which enables the system to determine the cost of optimized piping layout for a new water network. In some embodiments, this functionality allows customers to make an informed decision about implementation based on a calculated payback period.

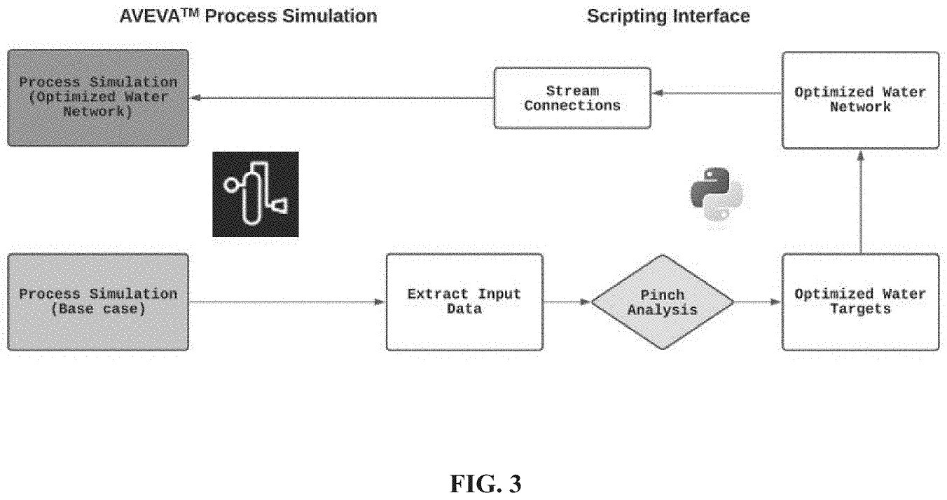

FIG. 3 illustrates a non-limiting example process flow according to some embodiments. In some embodiments, the first step in the process is to build a simulation model of the manufacturing process using, as a non-limiting example, AVEVA® simulation software. In some embodiments, the system is configured to determine one or more water quality metrics and/or mass flowrates from the process model. In some embodiments, the system includes one or more sensors monitoring one or more process components (e.g., process equipment, piping, etc.). In some embodiments, the process model is configured to receive data from the one or more sensors as inputs into the process model. In some embodiments, the process model is a digital twin of a real (physical) process.

In some embodiments, the system is configured to determine one or more sources of contamination from the process model. In some embodiments, the system is configured to determine the largest source of contamination as a first source and distribute the source to one or more sinks that can accept a fluid with that level of contamination. In some embodiments, the system is useful for completed operational processes because the operational process provides the data to feed into the process model from one or more sensors and/or historical databases with one or more testing results. In some embodiments, the system is configured to create a new process model based on the analysis, which is a new capability previously unachieved in the art.

In some embodiments, the process model includes a digital twin. In some embodiments, the digital twin is configured to interface with a manufacturing control system (e.g., a SCADA package) to execute one or more process operations. In some embodiments, process operations include, as non-limiting examples, sending a notification to an operator, near real-time display of fluid quality, and/or suggesting line-ups for more efficient use of sources and sinks based on a near real-time data feedback loop. As process or raw material changes, the contaminates change as well, and the system is configured to constantly monitor the process and suggest new sources and sinks based on current or near-current process conditions.

In some embodiments, the system includes an optimization algorithm. In some embodiments, the optimization algorithm is configured to enable a user to input constraints on the system into the process model. As a non-limiting example, if a sink is separated from a source by a distance to where it would be uneconomical to create new piping, the system can be configured to assign the constrained sink as an unviable option within the analysis. In some embodiments, the system is configured to suggest the constrained sink as an option and/or provide a cost benefit analysis for adding supporting structure such as new piping, pumps, electrical connections, etc.

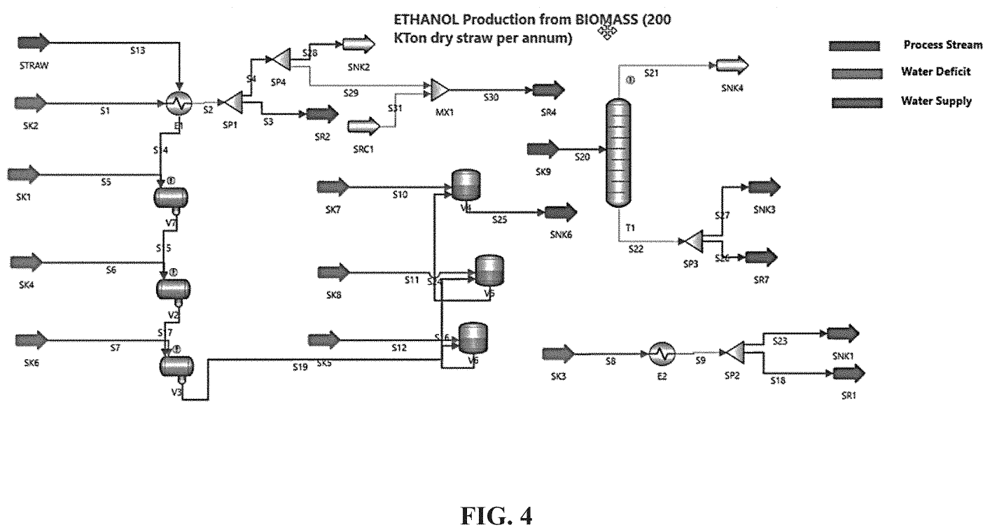

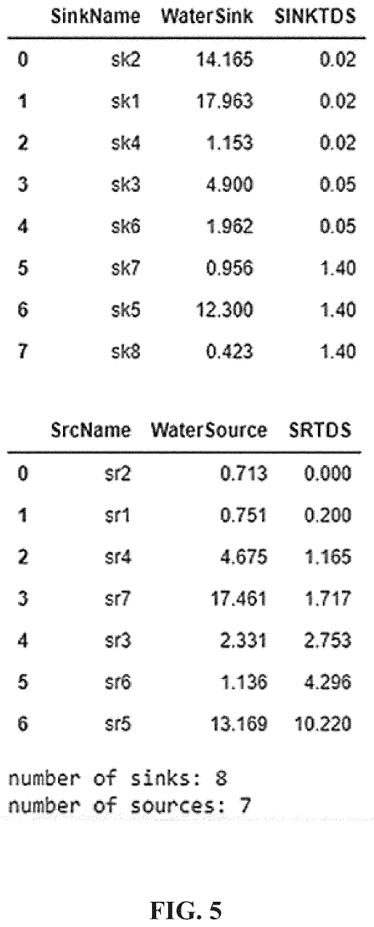

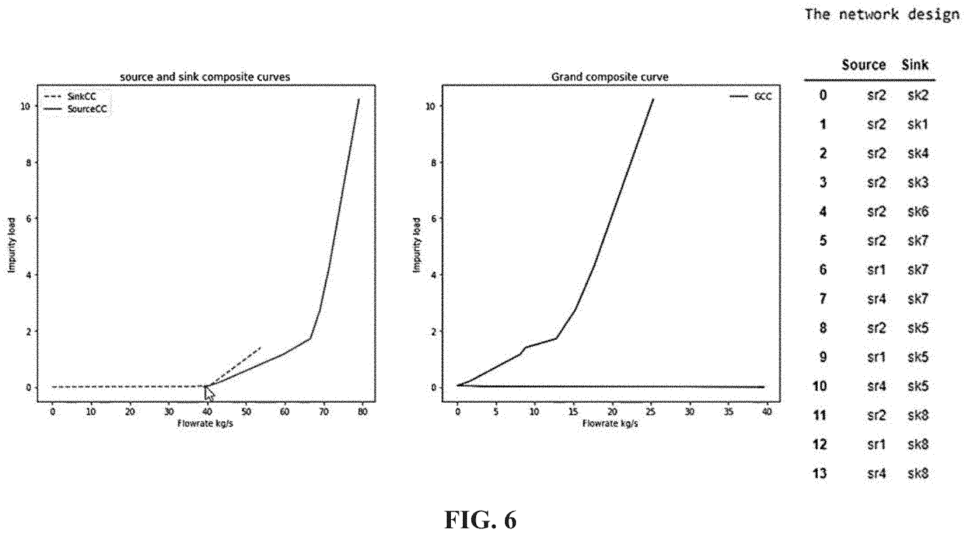

FIG. 4 shows an ethanol process as a non-limiting example of a use case according to some embodiments. In some embodiments, as the sugars in the straw are converted to ethanol in various stages, the process requires approximately 54 kg/s of fresh water and discharges about 40.2 kg/s of wastewater before optimization. FIG. 5 shows a first step of collecting the data of each source and sink according to some embodiments. FIG. 6 shows a second step of feeding the data into the system for the pinch analysis to determine the pinch point and/or optimized network design according to some embodiments. In some embodiments, the optimized network design includes a table which shows which sources and sinks should be linked together. In some embodiments, a third step is to feed the analysis back to the simulation software where new connections are formed automatically according to the analysis.

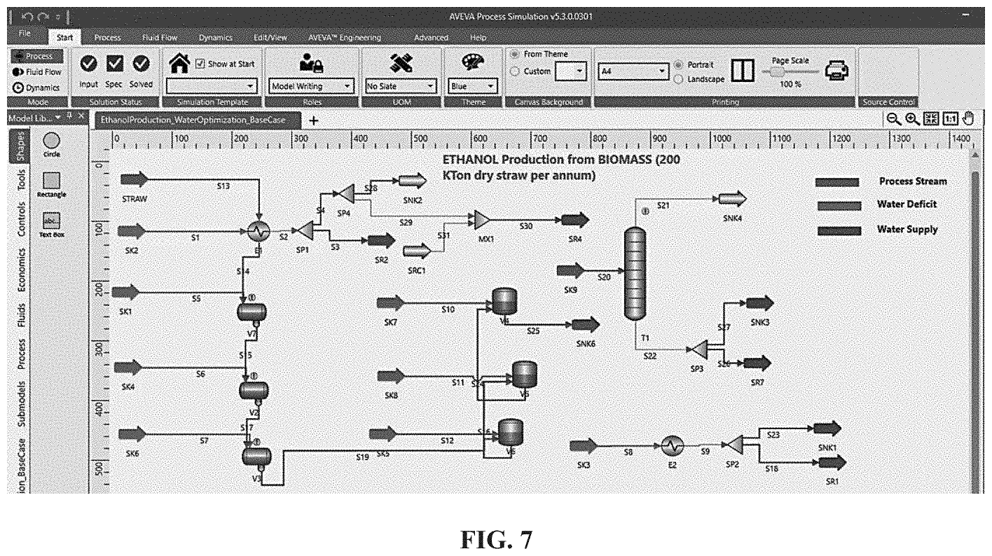

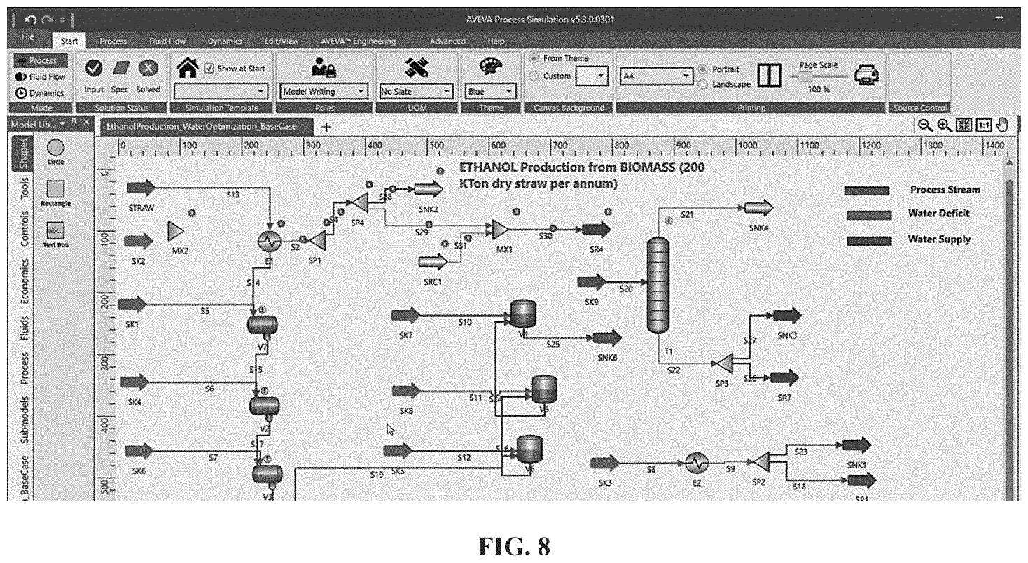

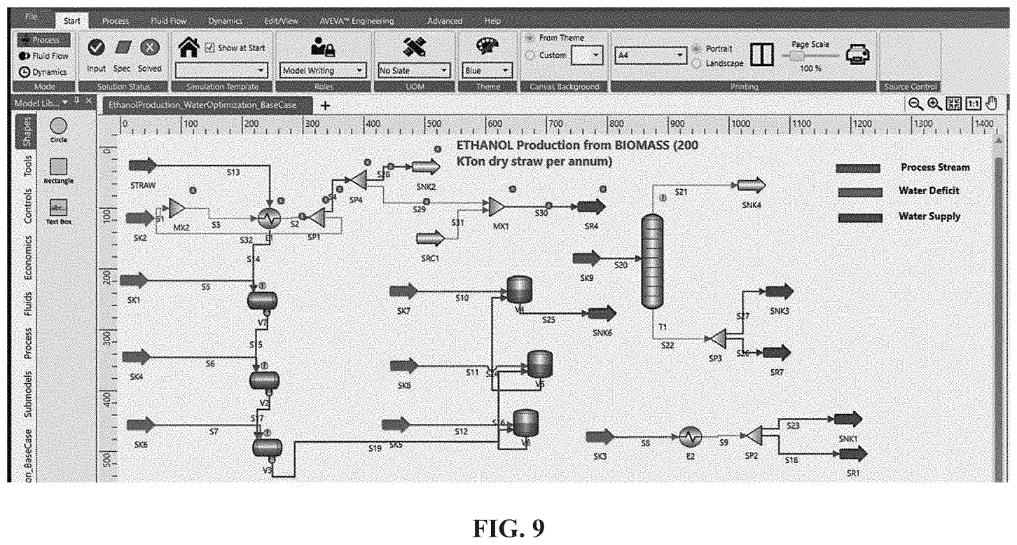

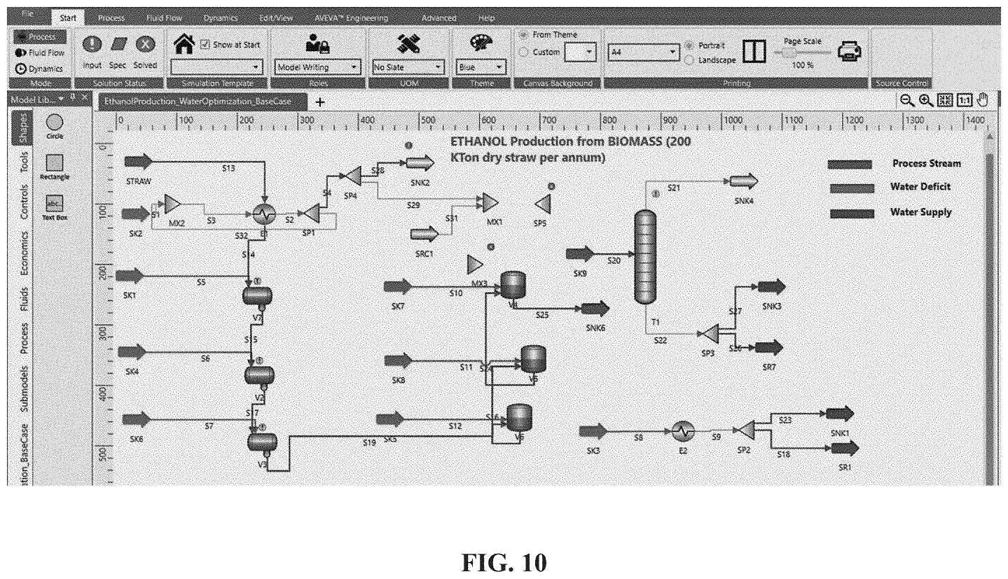

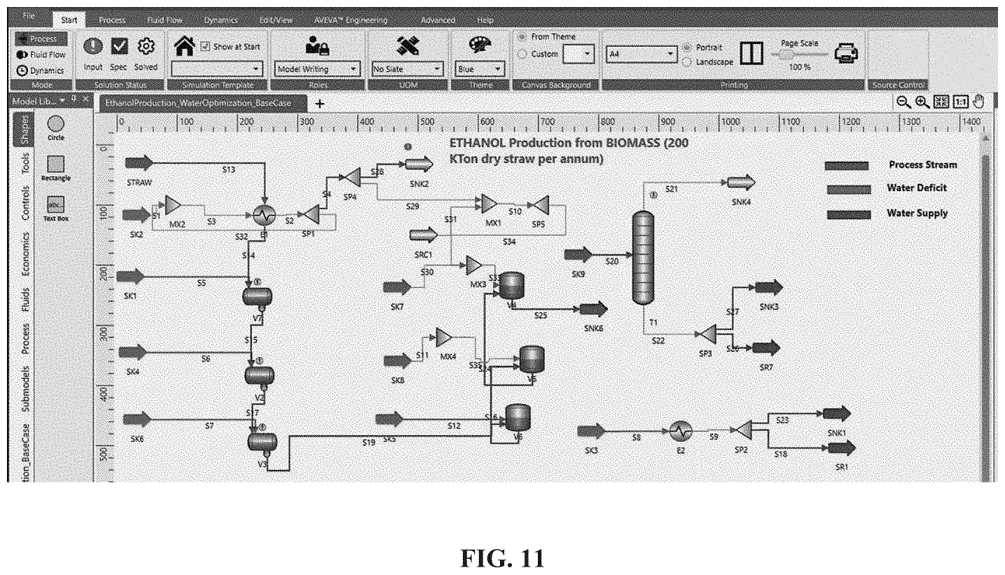

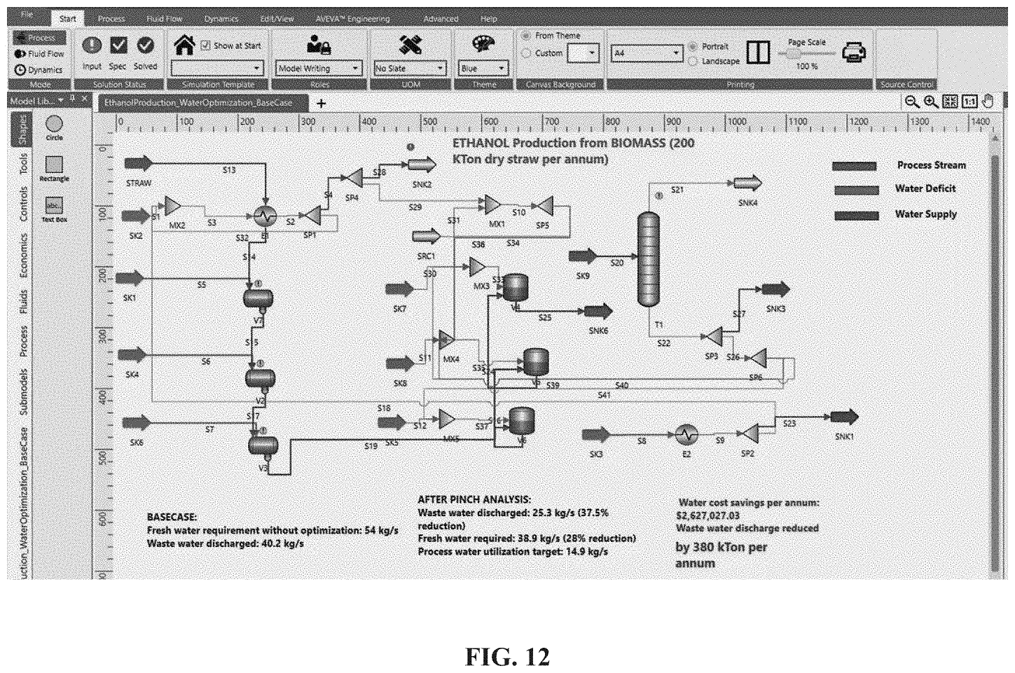

FIGS. 7-12 depict various stages of the system automatically generating the new connections in the model according to some embodiments. In some embodiments, the new configuration results in a 37.5% reduction in wastewater discharge, as well as a 28% reduction in required freshwater intake, with an estimated savings of $2.6 million U.S. dollars per year.

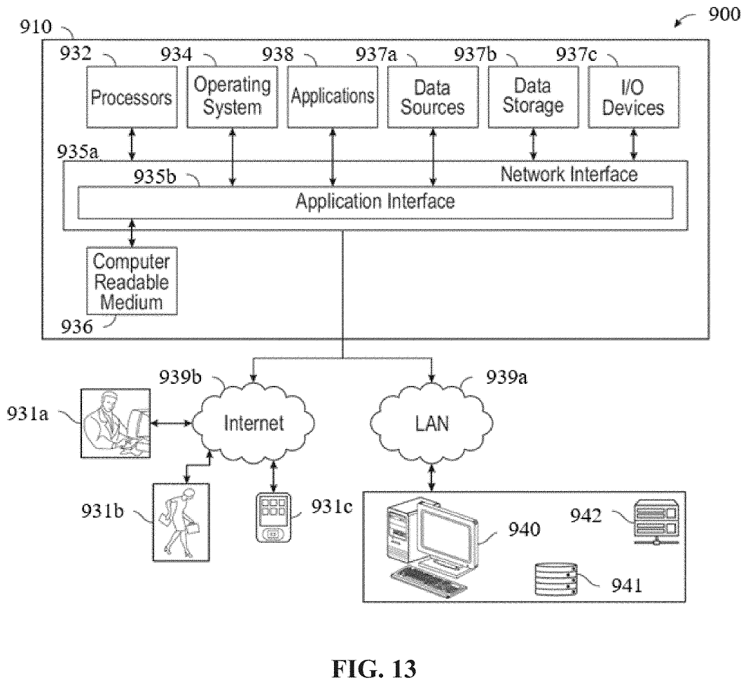

FIG. 13 illustrates a computer system 910 enabling or comprising the systems and methods in accordance with some embodiments of the system. In some embodiments, the computer system 910 can operate and/or process computer-executable code of one or more software modules of the aforementioned system and method. Further, in some embodiments, the computer system 910 can operate and/or display information within one or more graphical user interfaces (e.g., HMIs) integrated with or coupled to the system.

In some embodiments, the computer system 910 can comprise at least one processor 932. In some embodiments, the at least one processor 932 can reside in, or coupled to, one or more conventional server platforms (not shown). In some embodiments, the computer system 910 can include a network interface 935a and an application interface 935b coupled to the least one processor 932 capable of processing at least one operating system 934. Further, in some embodiments, the interfaces 935a, 935b coupled to at least one processor 932 can be configured to process one or more of the software modules (e.g., such as enterprise applications 938). In some embodiments, the software application modules 938 can include server-based software and can operate to host at least one user account and/or at least one client account, and operate to transfer data between one or more of these accounts using the at least one processor 932.

With the above embodiments in mind, it is understood that the system can employ various computer-implemented operations involving data stored in computer systems. Moreover, the above-described databases and models described throughout this disclosure can store analytical models and other data on computer-readable storage media within the computer system 910 and on computer-readable storage media coupled to the computer system 910 according to various embodiments. In addition, in some embodiments, the above-described applications of the system can be stored on computer-readable storage media within the computer system 910 and on computer-readable storage media coupled to the computer system 910. In some embodiments, these operations are those requiring physical manipulation of physical quantities. Usually, though not necessarily, in some embodiments these quantities take the form of one or more of electrical, electromagnetic, magnetic, optical, or magneto-optical signals capable of being stored, transferred, combined, compared and otherwise manipulated. In some embodiments, the computer system 910 can comprise at least one computer readable medium 936 coupled to at least one of at least one data source 937a, at least one data storage 937b, and/or at least one input/output 937c. In some embodiments, the computer system 910 can be embodied as computer readable code on a computer readable medium 936. In some embodiments, the computer readable medium 936 can be any data storage that can store data, which can thereafter be read by a computer (such as computer 940). In some embodiments, the computer readable medium 936 can be any physical or material medium that can be used to tangibly store the desired information or data or instructions and which can be accessed by a computer 940 or processor 932. In some embodiments, the computer readable medium 936 can include hard drives, network attached storage (NAS), read-only memory, random-access memory, FLASH based memory, CD-ROMs, CD-Rs, CD-RWs, DVDs, magnetic tapes, other optical and non-optical data storage. In some embodiments, various other forms of computer-readable media 936 can transmit or carry instructions to a remote computer 940 and/or at least one user 931, including a router, private or public network, or other transmission or channel, both wired and wireless. In some embodiments, the software application modules 938 can be configured to send and receive data from a database (e.g., from a computer readable medium 936 including data sources 937a and data storage 937b that can comprise a database), and data can be received by the software application modules 938 from at least one other source. In some embodiments, at least one of the software application modules 938 can be configured within the computer system 910 to output data to at least one user 931 via at least one graphical user interface rendered on at least one digital display.

In some embodiments, the computer readable medium 936 can be distributed over a conventional computer network via the network interface 935a where the system embodied by the computer readable code can be stored and executed in a distributed fashion. For example, in some embodiments, one or more components of the computer system 910 can be coupled to send and/or receive data through a local area network (“LAN”) 939a and/or an internet coupled network 939b (e.g., such as a wireless internet). In some embodiments, the networks 939a, 939b can include wide area networks (“WAN”), direct connections (e.g., through a universal serial bus port), or other forms of computer-readable media 936, or any combination thereof.

In some embodiments, components of the networks 939a, 939b can include any number of personal computers 940 which include for example desktop computers, and/or laptop computers, or any fixed, generally non-mobile internet appliances coupled through the LAN 939a. For example, some embodiments include one or more of personal computers 940, databases 941, and/or servers 942 coupled through the LAN 939a that can be configured for any type of user including an administrator. Some embodiments can include one or more personal computers 940 coupled through network 939b. In some embodiments, one or more components of the computer system 910 can be coupled to send or receive data through an internet network (e.g., such as network 939b). For example, some embodiments include at least one user 931a, 931b, is coupled wirelessly and accessing one or more software modules of the system including at least one enterprise application 938 via an input and output (“I/O”) 937c. In some embodiments, the computer system 910 can enable at least one user 931a, 931b, to be coupled to access enterprise applications 938 via an I/O 937c through LAN 939a. In some embodiments, the user 931 can comprise a user 931a coupled to the computer system 910 using a desktop computer, and/or laptop computers, or any fixed, generally non-mobile internet appliances coupled through the internet 939b. In some embodiments, the user can comprise a mobile user 931b coupled to the computer system 910. In some embodiments, the user 931b can connect using any mobile computing 931c to wireless coupled to the computer system 910, including, but not limited to, one or more personal digital assistants, at least one cellular phone, at least one mobile phone, at least one smart phone, at least one pager, at least one digital tablets, and/or at least one fixed or mobile internet appliances.

The subject matter described herein are directed to technological improvements to the field of waste fluid management by automatically generating paths for waste fluid that reduces the need for make-up fluid into a component in an industrial process. The disclosure describes the specifics of how a machine including one or more computers comprising one or more processors and one or more non-transitory computer readable media implement the system and its improvements over the prior art. The instructions executed by the machine cannot be performed in the human mind or derived by a human using a pen and paper but require the machine to convert process input data to useful output data. Moreover, the claims presented herein do not attempt to tie-up a judicial exception with known conventional steps implemented by a general-purpose computer; nor do they attempt to tie-up a judicial exception by simply linking it to a technological field. Indeed, the systems and methods described herein were unknown and/or not present in the public domain at the time of filing, and they provide technologic improvements advantages not known in the prior art. Furthermore, the system includes unconventional steps that confine the claim to a useful application.

It is understood that the system is not limited in its application to the details of construction and the arrangement of components set forth in the previous description or illustrated in the drawings. The system and methods disclosed herein fall within the scope of numerous embodiments. The previous discussion is presented to enable a person skilled in the art to make and use embodiments of the system. Any portion of the structures and/or principles included in some embodiments can be applied to any and/or all embodiments: it is understood that features from some embodiments presented herein are combinable with other features according to some other embodiments. Thus, some embodiments of the system are not intended to be limited to what is illustrated but are to be accorded the widest scope consistent with all principles and features disclosed herein.

Some embodiments of the system are presented with specific values and/or setpoints. These values and setpoints are not intended to be limiting and are merely examples of a higher configuration versus a lower configuration and are intended as an aid for those of ordinary skill to make and use the system.

Furthermore, acting as Applicant's own lexicographer, Applicant imparts the explicit meaning and/or disavow of claim scope to the following terms:

Applicant defines any use of “and/or” such as, for example, “A and/or B,” or “at least one of A and/or B” to mean element A alone, element B alone, or elements A and B together. In addition, a recitation of “at least one of A, B, and C,” a recitation of “at least one of A, B, or C,” or a recitation of “at least one of A, B, or C or any combination thereof” are each defined to mean element A alone, element B alone, element C alone, or any combination of elements A, B and C, such as AB, AC, BC, or ABC, for example.

“Substantially” and “approximately” when used in conjunction with a value encompass a difference of 5% or less of the same unit and/or scale of that being measured.

“Simultaneously” as used herein includes lag and/or latency times associated with a conventional and/or proprietary computer, such as processors and/or networks described herein attempting to process multiple types of data at the same time. “Simultaneously” also includes the time it takes for digital signals to transfer from one physical location to another, be it over a wireless and/or wired network, and/or within processor circuitry.

As used herein, “can” or “may” or derivations there of (e.g., the system display can show X) are used for descriptive purposes only and is understood to be synonymous and/or interchangeable with “configured to” (e.g., the computer is configured to execute instructions X) when defining the metes and bounds of the system.

In addition, the term “configured to” means that the limitations recited in the specification and/or the claims must be arranged in such a way to perform the recited function: “configured to” excludes structures in the art that are “capable of” being modified to perform the recited function but the disclosures associated with the art have no explicit teachings to do so. For example, a recitation of a “container configured to receive a fluid from structure X at an upper portion and deliver fluid from a lower portion to structure Y” is limited to systems where structure X, structure Y, and the container are all disclosed as arranged to perform the recited function. The recitation “configured to” excludes elements that may be “capable of” performing the recited function simply by virtue of their construction but associated disclosures (or lack thereof) provide no teachings to make such a modification to meet the functional limitations between all structures recited. Another example is “a computer system configured to or programmed to execute a series of instructions X, Y, and Z.” In this example, the instructions must be present on a non-transitory computer readable medium such that the computer system is “configured to” and/or “programmed to” execute the recited instructions: “configure to” and/or “programmed to” excludes art teaching computer systems with non-transitory computer readable media merely “capable of” having the recited instructions stored thereon but have no teachings of the instructions X, Y, and Z programmed and stored thereon. The recitation “configured to” can also be interpreted as synonymous with operatively connected when used in conjunction with physical structures.

It is understood that the phraseology and terminology used herein is for description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

The previous detailed description is to be read with reference to the figures, in which like elements in different figures have like reference numerals. The figures, which are not necessarily to scale, depict some embodiments and are not intended to limit the scope of embodiments of the system.

Any of the operations described herein that form part of the invention are useful machine operations. The invention also relates to a device or an apparatus for performing these operations. The apparatus can be specially constructed for the required purpose, such as a special purpose computer. When defined as a special purpose computer, the computer can also perform other processing, program execution or routines that are not part of the special purpose, while still being capable of operating for the special purpose. Alternatively, the operations can be processed by a general-purpose computer selectively activated or configured by one or more computer programs stored in the computer memory, cache, or obtained over a network. When data is obtained over a network the data can be processed by other computers on the network, e.g., a cloud of computing resources.

The embodiments of the invention can also be defined as a machine that transforms data from one state to another state. The data can represent an article, that can be represented as an electronic signal and electronically manipulate data. The transformed data can, in some cases, be visually depicted on a display, representing the physical object that results from the transformation of data. The transformed data can be saved to storage generally, or in particular formats that enable the construction or depiction of a physical and tangible object. In some embodiments, the manipulation can be performed by a processor. In such an example, the processor thus transforms the data from one thing to another. Still further, some embodiments include methods can be processed by one or more machines or processors that can be connected over a network. Each machine can transform data from one state or thing to another, and can also process data, save data to storage, transmit data over a network, display the result, or communicate the result to another machine. Computer-readable storage media, as used herein, refers to physical or tangible storage (as opposed to signals) and includes without limitation volatile and non-volatile, removable and non-removable storage media implemented in any method or technology for the tangible storage of information such as computer-readable instructions, data structures, program modules or other data.

Although method operations are presented in a specific order according to some embodiments, the execution of those steps do not necessarily occur in the order listed unless explicitly specified. Also, other housekeeping operations can be performed in between operations, operations can be adjusted so that they occur at slightly different times, and/or operations can be distributed in a system which allows the occurrence of the processing operations at various intervals associated with the processing, as long as the processing of the overlay operations are performed in the desired way and result in the desired system output.

It will be appreciated by those skilled in the art that while the invention has been described above in connection with particular embodiments and examples, the invention is not necessarily so limited, and that numerous other embodiments, examples, uses, modifications and departures from the embodiments, examples and uses are intended to be encompassed by the claims attached hereto. The entire disclosure of each patent and publication cited herein is incorporated by reference, as if each such patent or publication were individually incorporated by reference herein. Various features and advantages of the invention are set forth in the following claims.

We claim:

1. A system for determining routing for wastewater in an industrial process comprising:
one or more computers comprising one or more processors and one or more non-transitory computer readable media, the one or more non-transitory computer readable media having instructions stored thereon that when executed cause the one or more computers to:
receive, by the one or more processors, one or more contamination threshold values for each of one or more fluid processes;
receive, by the one or more processors, contamination production data for each of the one or more fluid processes;
execute, by the one or more processors, one or more contamination calculations; and
determine, by the one or more processors, a contaminated fluid route;
where the contaminated fluid route comprises a representation of one or more industrial components needed to route contaminated fluid from at least one of the one or more fluid processes to at least one other of the one or more fluid processes.

2. The system of claim 1,
wherein the one or more non-transitory computer readable media have further instructions stored thereon that when executed cause the one or more computers to:
generate, by the one or more processors, a simulation model of an industrial process comprising the contaminated fluid route.

3. The system of claim 2, further comprising:
one or more controllers;
wherein the one or more non-transitory computer readable media have further instructions stored thereon that when executed cause the one or more computers to:
send, by the one or more processors, a command to the one or more controllers to change a physical component line-up to initiate the contaminated fluid route.

4. The system of claim 2,
wherein contamination production data comprises a contamination concentration comprising one or more types of contamination per unit of fluid leaving one or more of the one or more fluid processes.

5. The system of claim 4,
wherein each of one or more contamination calculations are configured to determine a rate at which contaminated fluid can be received by a respective each of the one or more fluid processes before a respective contamination threshold value is reached for each of the one or more fluid processes; and
wherein the respective contamination threshold value includes a limit to the contamination concentration.

6. The system of claim 4,
wherein each of one or more contamination calculations are configured to determine an amount of contaminated fluid that can be received by a respective each of the one or more fluid processes before a respective contamination threshold value is reached for each of the one or more fluid processes; and
wherein the respective contamination threshold value includes a limit to the contamination concentration.

7. The system of claim 1,
wherein the one or more non-transitory computer readable media have further instructions stored thereon that when executed cause the one or more computers to:
generate, by the one or more processors, the contaminated fluid route in a simulation model of an industrial process comprising the one or more fluid processes; and
assign, by the one or more processors, one or more source component designations or one or more sink component designations for each of the one or more fluid processes.

8. The system of claim 7,
wherein the one or more sink component designations are configured to execute a sink process that at least partially requires an input of a same process fluid that the one or more source component designations use to execute a source process.

9. The system of claim 7,
wherein the one or more source component designations are based on a source fluid output from the one or more fluid processes comprising a higher contamination value than a source fluid input to the one or more fluid processes.

10. The system of claim 9,
wherein the one or more sink component designations are based on a sink fluid output from the one or more fluid processes, the sink fluid output comprising a lower contamination value than the source fluid output; and
wherein the one or more sink component designations are based on a contamination value of the sink fluid output being below a respective contamination threshold value.

11. A system for determining routing for wastewater in an industrial process comprising:
one or more computers comprising one or more processors and one or more non-transitory computer readable media, the one or more non-transitory computer readable media having instructions stored thereon that when executed cause the one or more computers to:
generate, by the one or more processors, an industrial simulation of a physical industrial process, the industrial simulation comprising one or more representations of one or more fluid processes;
receive, by the one or more processors, one or more waste fluid threshold values for each of one or more fluid processes;
receive, by the one or more processors, waste fluid production data for each of one or more fluid processes;
execute, by the one or more processors, one or more waste fluid calculations; and
generate, by the one or more processors, one or more waste fluid routing proposals on the industrial simulation;
wherein each of one or more waste fluid calculations are configured to determine an amount of waste fluid that can be received by a respective each of the one or more fluid processes; and
wherein each of the one or more waste fluid routing proposals include one or more digital components configured to deliver one or more source fluid outputs comprising waste fluid to one or more one sink components within the industrial simulation.

12. The system of claim 11,
wherein at least one of the one or more digital components represent existing components in the physical industrial process.

13. The system of claim 11,
wherein at least one of the one or more digital components comprise a suggested component; and
wherein the suggested component does not currently exist in the physical industrial process.

14. The system of claim 11,
wherein the one or more non-transitory computer readable media have further instructions stored thereon that when executed cause the one or more computers to:
execute, by the one or more processors, an optimization simulation;
wherein the optimization simulation includes one or more waste fluid routing proposal simulations; and
wherein the optimization simulation includes at least partially replacing existing fluid entering one or more sink components with waste fluid from one or more source components.

15. The system of claim 14,
wherein the one or more non-transitory computer readable media have further instructions stored thereon that when executed cause the one or more computers to:
execute, by the one or more processors, a change in physical component line-up in the physical industrial process to initiate the one or more waste fluid routing proposals.

16. The system of claim 15,
wherein the one or more non-transitory computer readable media have further instructions stored thereon that when executed cause the one or more computers to:
execute, by the one or more processors, a contamination sink flowrate calculation;
where the contamination sink flowrate calculation is configured to provide a flowrate of waste fluid to the one or more sink components that results in a sink component fluid output remaining below a contamination threshold value.

17. The system of claim 11,
wherein the one or more waste fluid routing proposals includes a lowest cost calculation; and
wherein the lowest cost calculation includes a selection of physical components that require a lowest energy for transporting the one or more source fluid outputs to the one or more sink components.

18. The system of claim 11,
wherein the one or more waste fluid routing proposals include a lowest cost calculation; and
wherein the lowest cost calculation includes a selection of physical components that require a lowest cost for transporting the one or more source fluid outputs to the one or more sink components.

19. The system of claim 11,
wherein the one or more waste fluid routing proposals include a lowest cost calculation; and
wherein the lowest cost calculation includes an optimized component calculation; wherein the optimized component calculation includes one or more suggested new components required to transport the one or more source fluid outputs to the one or more sink components.

20. The system of claim 19,
wherein the one or more suggested new components are selected by determining a lowest cost of available component options, including pipes, valves, and/or pumps.
